(19) United States
(12) Patent Application Publication
(10) Pub. No.: US 2011/0024237 A1
(43) Pub. Date: Feb. 3, 2011

(54) SLOPE LIFT FOR CLIMBING OR DESCENDING A SLOPE OR STAIRS

(75) Inventor: Dennis Vroegindeweij, Ursem (NL)

Correspondence Address: HOFFMANN & BARON, LLP, 6900 JERICHO TURNPIKE, SYOSSET, NY, 11791, US

(73) Assignee: FREELIFT B.V., Heerhugowaard (NL)

(21) Appl. No.: 12/745,580

(22) PCT Filed: Dec. 10, 2008
(86) PCT No.: PCT/NL08/00274

§ 371 Date: Oct. 19, 2010

(30) Foreign Application Priority Data
Dec. 17, 2007 (NL) 2001096

(51) Int. Cl. B66B 9/08

(52) U.S. Cl. 187/201

(57) ABSTRACT

The invention relates to a slope lift for climbing or descending a slope or stairs along a guide (9), provided with a transport unit (3), configured to be carried by the guide and to advance along the guide, wherein the transport unit comprises a main frame (11) and a first and second subframe (13, 15), wherein the subframes are provided with at least two guide wheels (39, 41, 17) which guide the transport unit along the guide and the main frame is provided with a support wheel (25) and a drive wheel (19) connected to a drive (21) which advances the transport unit along the guide. The first subframe and the main frame are coupled together in such a way that the movements of the first subframe and the main frame are mirror-symmetrical with respect to a plane of symmetry located between the first subframe and the main frame.

### CROSS-REFERENCE TO RELATED APPLICATIONS

This application is the National Stage of International Application No. PCT/NL2008/000274, filed Dec. 10, 2008, which claims the benefit of Netherlands Application No. NL 2001096, filed Dec. 17, 2007, the contents of which is incorporated by reference herein.

### FIELD OF THE INVENTION

The invention relates to a slope lift for climbing or descending a slope or stairs along a guide, provided with a transport unit, configured to be carried by the guide and to advance along the guide, wherein the transport unit comprises a main frame and a first and second subframe, wherein the subframes are provided with at least two guide wheels which guide the transport unit along the guide, and the main frame is provided with a main frame guide wheel and a drive wheel connected to a drive which advances the transport unit along the guide.

### BACKGROUND OF THE INVENTION

A lift is known from Netherlands patent 1001327. The lift known therefrom is provided with a running mechanism for a drive device of a rail-guiding displacement device such as a passenger lift, comprising a base part, drive means and at least two sets of guide wheels, attached one after the other, viewed in the direction of travel of the running mechanism, in such a way that during use the running mechanism is guided by the guide wheels in a desired position along the rail, wherein the base part comprises at least a bridge piece, a first and a second frame part, wherein the frame parts are each connected to the bridge piece so as to be able to move about at least one swivel axis, wherein each frame part carries a set of guide wheels and wherein the frame parts are coupled together by coupling means forming a mechanical mirror in such a way that the movements of the first and second frame part are at all times one another's mirror image in a mirror plane extending at right angles to the drive device of the running mechanism between the first and the second frame part and viewed with respect to the bridge piece. For the advancement, the known slope lift is provided with a drive wheel which is securely connected to the bridge piece, wherein the bridge piece is connected to the frame parts via a bearing. The axis of rotation of the drive wheel lies preferably in the mirror plane.

A drawback of the known lift is the fact that the connection by means of a bearing of the bridge piece to the frame parts does not ensure that the drive wheel is optimally aligned with the rail.

### SUMMARY OF THE INVENTION

The invention seeks to provide a slope lift which at least partially overcomes this above-mentioned drawback or at least offers an alternative thereto.

The invention achieves this object by means of a slope lift according to the present invention.

An advantage of the slope lift according to the present invention is the fact that the first subframe can move with respect to the main frame in such a way that both can perform a mirror-symmetrical movement with respect to a plane of symmetry located between the main frame and the first subframe. The axes of the guide wheels and the drive wheel then lie in a plane intersecting the guide at right angles. The guide wheels and the drive wheel of the transport unit are then continuously in a position with respect to the guide such that the running plane of the wheel in question is located parallel to a tangent line of the guide in such a way that each wheel can pass, when passing through a bend in the guide, through said bend while rolling in an optimum manner. In addition, this transport unit offers the advantage that each movement of the first subframe is reflected by the subsequent or preceding main frame. As a result, for example when entering a bend, the preceding guide wheels adapt the position of the subframe in question in such a way that the guide wheels follow substantially the ideal line. In this case, the coupling adapts the position of the main frame to the bend to be passed through, as a result of which, of this main frame too, the drive wheel follows the ideal line.

A further advantage is the fact that a connection between the frame parts by means of a bridge part and a bearing is superfluous in a slope lift according to the invention. This is advantageous because it simplifies the design.

Advantageous embodiments are defined in the sub-claims.

### BRIEF DESCRIPTION OF THE DRAWINGS

The invention will be described in greater detail on the basis of a description of the accompanying figures, in which:

FIG. 1 shows a first embodiment of the slope lift, such as a stair lift, according to the invention;

FIG. 2 is a view from below of the first embodiment of the slope lift according to the invention;

FIG. 3 is a side view of the first embodiment of the slope lift according to the invention;

FIG. 4a shows an exploded main frame of the slope lift according to the invention;

FIG. 4b shows an alternative embodiment of a transport unit for a slope lift;

FIG. 5 shows a second embodiment of the slope lift according to the invention;

FIG. 6 shows a third embodiment of the slope lift according to the invention; and

FIG. 7 is a view from below of the third embodiment of the slope lift according to the invention.

### DETAILED DESCRIPTION OF THE PREFERRED EMBODIMENTS

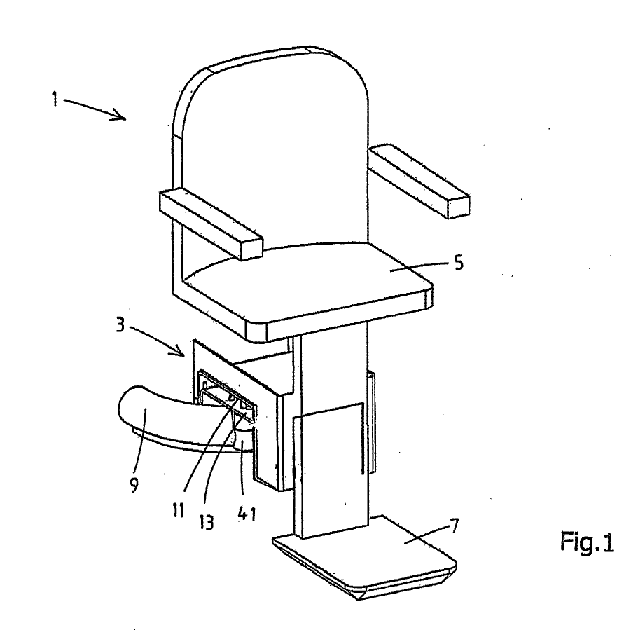

FIG. 1 is a front view of a slope lift 1, such as a stair lift provided with a chair 5 and a foot rest 7. The slope lift 1 for climbing or descending a slope or stairs along a guide 9 is provided with a transport unit 3, configured to be carried by the guide 9 and to advance along the guide 9. The transport unit 3 comprises a main frame 11 and a first subframe 13. The first subframe 13 is provided with at least two guide wheels, one 41 of which may be seen, which guide the transport unit 3 along the guide 9.

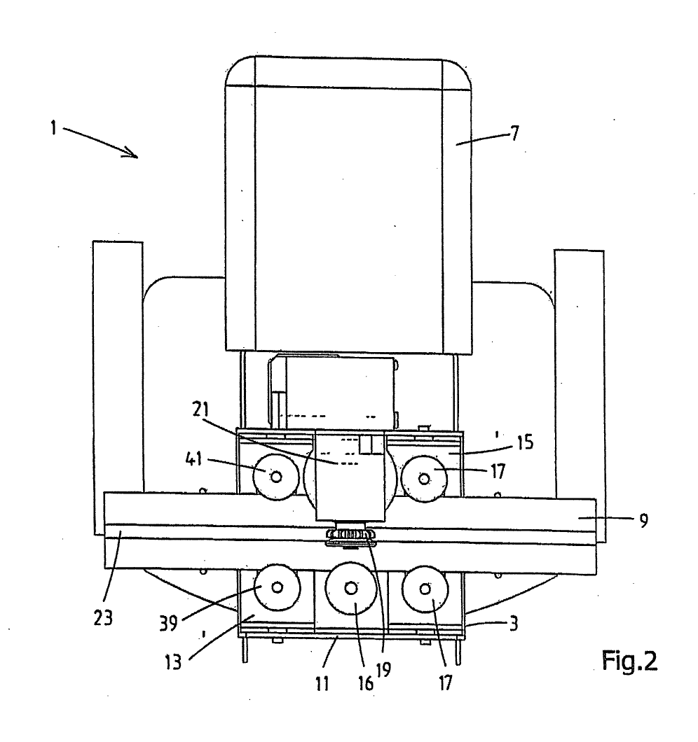

FIG. 2 is a view from below of the slope lift 1 according to the invention. The view from below shows the first subframe 13 and a second subframe 15. The first subframe 13 is provided with two guide wheels 39, 41 and the second subframe 15 is also provided with two guide wheels 17. The main frame 11 is provided with a main frame guide wheel 16 and a drive wheel connected to a drive 21 which advances the transport unit 3 along the guide 9. The drive wheel is for this purpose provided with a gear wheel 19 which engages with a gear rack 23 of guide 9.

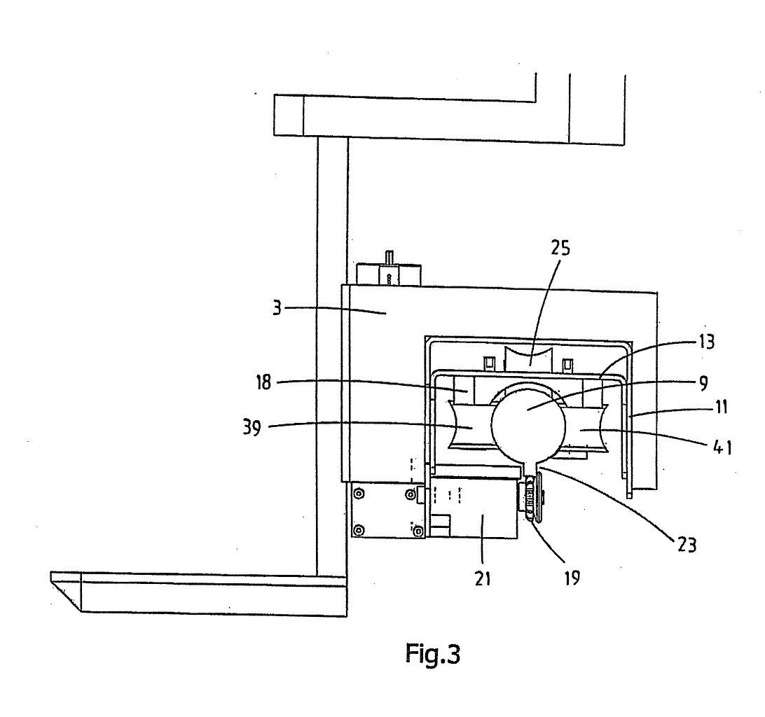

FIG. 3 is a side view of a portion of the slope lift according to the invention in the direction of the guide 9. The transport unit 3 is provided with the main frame 11 having a support wheel 25 which supports the transport unit 3 on the guide 9 and ensures that the gear wheel 19 is pressed against the gear rack 23. The main frame 11 is connected to the subframe 13 which is provided with a running mechanism comprising two guide wheels 39, 41 and a wheel holder 18.

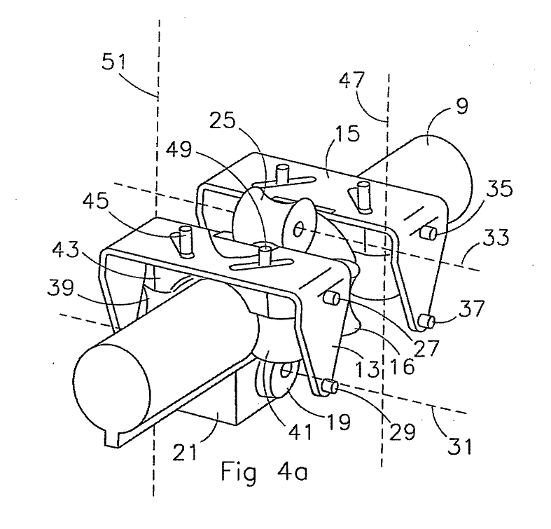

FIG. 4a shows the exploded main frame 11 of FIGS. 1 to 3 inclusive. Support wheel 25, which is rotatably connected to the main frame, runs over the guide 9. On the underside, it is still just possible to see the drive 21 having the gear wheel 19 which is connected to the main frame.

The first subframe 13 is movably connected to the main frame via a first and a second subframe rotation point 27, 29. The first subframe rotation point 27 is embodied as a first pin which can move through a first slot in the main frame. The first slot has the shape of a section of a circle having a radius running from a first main frame rotation point of the main frame which lies on a first main frame axis of rotation 31. The first axis of rotation 31 passes through the axis of rotation of the gear wheel 19 in this embodiment, but this is not necessary in order to carry out the invention effectively. The second subframe rotation point 29 is embodied as a second pin which can move through a second slot in the main frame. The second slot has the shape of a section of a circle having a radius running from a second main frame rotation point which passes through a second main frame axis of rotation 33 of the main frame. The second axis of rotation 33 passes through the axis of rotation of the support wheel 25 in this embodiment, but this is not necessary in order to carry out the invention effectively. In order to carry out the invention effectively, it is necessary for the first and second axis of rotation 31, 33 both to be positioned at the same distance from the guide 9. The first and second subframe rotation point 27, 29 also have to be positioned at the same distance from the guide 9. As a result of this configuration, the main frame and the first subframe 13 are joined together in such a way that they move mirror-symmetrically with respect to each other in a first plane with respect to a mirror plane. The mirror plane is oriented predominantly perpendicularly with respect to the guide 9 and placed between the first subframe 13 and the main frame, more specifically between the first and second subframe rotation point 27, 29 and the first and second main frame rotation point. As a result of the fact that the subframe rotation points 27, 29 and the main frame rotation points are positioned close to the guide 9, a very compact construction of the transport unit 3 is possible. The compact construction allows the slope lift to be installed in narrow staircases and to turn short bends.

The second subframe 15 is movably connected to the main frame via a third and a fourth subframe rotation point 35, 37. The third subframe rotation point 35 is embodied as a third pin which can move through a third slot in the main frame. The third slot has the shape of a section of a circle having a radius running from third main frame rotation point of the main frame which in this case lies on the first main frame axis of rotation 31. The fourth subframe rotation point 37 is embodied as a fourth pin which can move through a fourth slot in the main frame. The fourth slot has the shape of a section of a circle having a radius running from a fourth main frame rotation point which in this case passes through the second main frame axis of rotation 33 of the main frame. As a result of this configuration, the main frame and the second subframe 15 are joined together in such a way that they move in a reflected manner with respect to each other with respect to a mirror plane located between the third and fourth subframe rotation point 35, 37 and the two axes of rotation 31, 33 of the main frame.

By embodying the subframe rotation points as a pin which can be moved in a slot of the main frame and by giving the slots a circular shape, wherein the circular shape is at a constant distance from the main frame rotation points of the main frame, the subframe rotation points can move in a compact manner in a circular shape with respect to the main frame rotation points of the main frame. The compact design has the advantage that not much space is necessary for the main frame and that it can as a result easily be installed in a transport unit for a slope lift. The pin/slot coupling means are embodied in a double manner, that is to say that on the side which is not visible in FIG. 4a the same rotation points and pin are attached as on the visible side. The double embodiment ensures that the forces are distributed more effectively and there is less wear in the pin/slot connections.

The first subframe 13 is provided with a running mechanism comprising two guide wheels 39, 41 and a first wheel holder 43. The first wheel holder 43 is connected to the first subframe 13 via a first wheel holder rotation point 45 which is embodied as a fifth pin which is suspended in the subframe 13 via a fifth slot. The fifth slot has a centre line which describes a portion of a circle having a constant distance with respect to a fifth main frame rotation point which lies on a third axis of rotation 47 of the main frame. The third axis of rotation 47 can optionally be formed by the axis of rotation of a main frame guide wheel 16 of the main frame. A second wheel holder rotation point 49 is embodied as a sixth pin which is movably suspended via a sixth circular slot in the first subframe 13 and can perform a circular movement with respect to a sixth main frame rotation point which lies on a fourth axis of rotation 51 of the main frame. The first and second wheel holder rotation point 45, 49 are movable with respect to the fifth and sixth main frame rotation point in the same second plane. The first plane wherein the subframes move with respect to the main frame and the second plane wherein the wheel holders move with respect to the main frame stand substantially perpendicularly to each other in this embodiment. If the transport unit passes through a two-dimensional bend, both the first subframe 13 and the wheel holder 43 will be tilted with respect to the main frame. The reference to the third and fourth axis of rotation 47, 51 is, as a result of tilting of the first subframe 13, no longer possible with precision; this reference applies even if the first subframe 13 is not tilted. Because the first and second wheel holder rotation point 45, 49 and the fifth and sixth main frame rotation point are positioned close to the guide 9, a very compact construction of the first subframe 13 is possible. The compact construction of the subframe 13 allows the transport unit 3 to be kept compact and the slope lift to be integrated in narrow staircases and to turn short bends.

The second subframe 15 is provided with a substantially identical wheel holder which is connected to the second subframe 15 in a comparable manner to that in which the wheel holder 43 is connected to the first subframe 13 and which can move in a comparable manner with respect to the fifth and sixth main frame rotation point (the axes of rotation 47 and 51). Both wheel holders move as a result in a mirror-symmetrical manner from the main frame in the second plane, and because the subframes also move in a mirror-symmetrical manner with respect to the main frame in the first plane, good guidance is ensured in both planes. The guide wheels of the subframes and the drive wheel, support wheel and the main frame guide wheels of the main frame are as a result continuously in a position with respect to the guide such that the running plane of the wheel in question is located parallel to a tangent line of the guide in such a way that each wheel can pass, when passing through a bend in the guide, through said band while rolling in an optimum manner. The wheel holders can be suspended tilted somewhat in the main frame so that they both can move in the same tilted third plane. The third tilted plane will no longer stand perpendicularly to the first plane. The main frame will then still be moved in the correct position when entering and leaving a bend. Tilted wheel holders have the advantage that a portion of the guide can be kept free for fastening to the wall in the staircase. As a result of the fact that there are a plurality of rotation points which ensure that the subframes 13, 15 and the main frame 11 move in a reflected manner, the forces are distributed more effectively and there is less wear than if one coupling means is used to make the subframe and the main frame move in a reflected manner.

FIG. 4b illustrates an alternative transport unit 3 consisting of the transport unit from FIG. 4a wherein one subframe has been omitted. Components in the alternative embodiment which correspond to components from FIGS. 1 to 4a inclusive are denoted in FIG. 4b by corresponding numerals. The transport unit 3 comprises a main frame and a subframe 13, wherein the main frame has been omitted in order clearly to show the subframe 13 and the wheels 41, 25, 16, 19. The first subframe 13 is movably connected to the main frame via a first and a second subframe rotation point 27, 29. The first subframe rotation point 27 is embodied as a first pin which can move through a first slot (not shown) in the main frame. The first slot has the shape of a section of a circle having a radius running from a first main frame rotation point of the main frame which lies on a first main frame axis of rotation 31. The first axis of rotation 31 passes through the axis of rotation of the gear wheel 19 in this embodiment, but this is not necessary in order to carry out the invention effectively. The second subframe rotation point 29 is embodied as a second pin which can move through a second slot (not shown) in the main frame. The second slot has the shape of a section of a circle having a radius running from a second main frame rotation point which passes through a second main frame axis of rotation 33 of the main frame. The second axis of rotation 33 passes through the axis of rotation of the support wheel 25 in this embodiment, but this is not necessary in order to carry out the invention effectively. In order to carry out the invention effectively, it is necessary for the first and second axis of rotation 31, 33 both to be positioned at the same distance from the guide 9. The first and second subframe rotation point 27, 29 must also be positioned at the same distance from the guide 9. As a result of this configuration, the main frame and the first subframe 13 are joined together in such a way that they move mirror-symmetrically with respect to each other in a first plane with respect to a mirror plane. The mirror plane is oriented predominantly perpendicularly with respect to the guide 9 and placed between the first subframe 13 and the main frame, more specifically between the first and second subframe rotation point 27, 29 and the first and second main frame rotation point. As a result of the fact that the subframe rotation points 27, 29 and the main frame rotation points are positioned close to the guide 9, a very compact construction of the transport unit 3 is possible. The compact construction of this embodiment wherein just one subframe is now present allows the transport unit to be made even more compact and to turn even shorter bends.

The first subframe 13 is provided with a running mechanism comprising two guide wheels 39, 41 and a first wheel holder. The first wheel holder is connected to the first subframe 13 via a first wheel holder rotation point 45 which is embodied as a fifth pin which is suspended in the subframe 13 via a fifth slot. The fifth slot has a centre line which describes a portion of a circle having a constant distance with respect to a fifth main frame rotation point which lies on a third axis of rotation 47 of the main frame. The third axis of rotation 47 can optionally be formed by the axis of rotation of a main frame guide wheel 16 of the main frame. A second wheel holder rotation point 49 is embodied as a sixth pin which is movably suspended via a sixth circular slot in the first subframe 13 and can perform a partial circular movement with respect to a sixth main frame rotation point which lies on a fourth axis of rotation (not visible) of the main frame. The slots which are formed in the first subframe are substantially similar to the slots which are formed (not shown) in the main frame in order to make the first and second subframe rotation point 27, 29 perform circular movements about the first and second main frame rotation point. The first and second wheel holder rotation point 45, 49 are movable with respect to the fifth and sixth main frame rotation point in the same second plane. The first plane wherein the subframes move with respect to the main frame and the second plane wherein the wheel holders move with respect to the main frame stand substantially perpendicularly to each other in this embodiment, but can also be tilted somewhat.

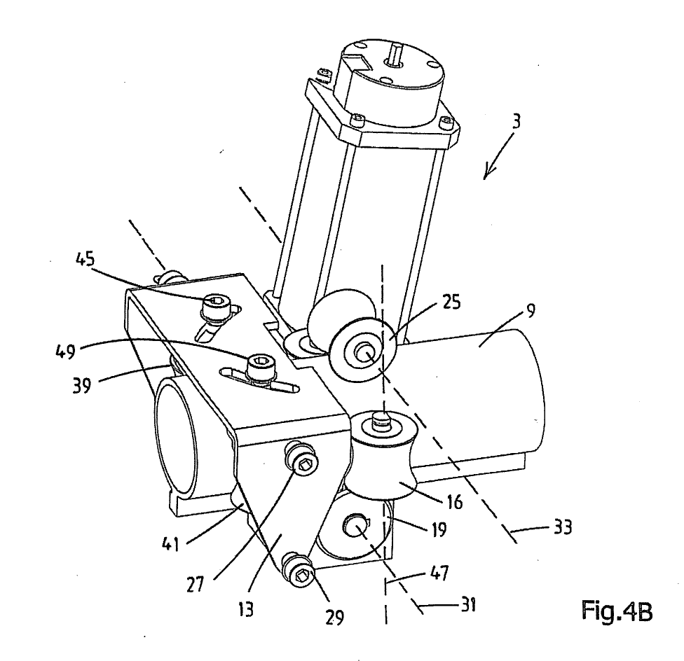

FIG. 5 shows a second embodiment of the slope lift according to the invention. Like components in the second embodiment are denoted by corresponding reference numerals. The slope lift is provided with a transport unit 3 which comprises a first and second subframe 13, and a main frame 11 which can be advanced over a guide rail 9. In the figure, a section of the guide rail 9 is visible; in reality, the guide rail will be slightly longer than it is shown here. The first and second subframe 13, 15 are provided with two guide wheels 17, 39, 41 and the main frame 11 is provided with two main frame guide wheels 16. The first subframe 13 has been connected to the main frame 11 via a first subframe hinge point 65, a first connecting rod 61 and a first main frame hinge point 63. By now connecting a second connecting rod 67 to a second main frame hinge point 71 via a second subframe hinge point 69, wherein the first and second connecting rod 61, 67 intersect each other, the movements of the subframe 13 and the main frame 11 can be reflected with respect to a first mirror plane 80 located between the guide wheels 39, 41 of the first subframe 13 and the wheels 17 of the main frame 11. In this embodiment, the mirror plane 80 is located halfway between the main frame 11 and the first subframe 13 at the intersection of the connecting rods 61, 67.

The second subframe 15 is connected to the first and second main frame hinge point 63, 71 by means of a third and fourth subframe hinge point 73, 75 and an intersecting third and fourth connecting rod 77, 79, as a result of which the movements between the second subframe 15 and the main frame 11 can be reflected over a second mirror plane 81. By coupling the first and second subframe 13, 15 mirror-symmetrically to the main frame 11 in such a way that mirror planes 80, 81 lie between the main frame 11 and the subframes 13, 15, the first and second subframe 13, 15 and the main frame 11 move in such a way over the guide rail that the frames 11, 13, 15 stand predominantly at right angles to the guide rail 9. The wheels of the frames 11, 13, 15 are as a result continuously in a position with respect to the guide 9 such that the running plane of the wheel in question is located parallel to a tangent line of the guide. An advantage of the second embodiment of FIG. 5 is the fact that the rods with hinge points offer better bearing than the slots, as a result of which there is less play and the positions of the guide wheels, support wheel and drive wheel are defined more clearly. The second embodiment of FIG. 5 is ideal for bends in the guide rail as specified. In order to be able also to pass through bends standing perpendicularly to this bend, similar connecting rods will have to be used in a direction perpendicular to the drawing.

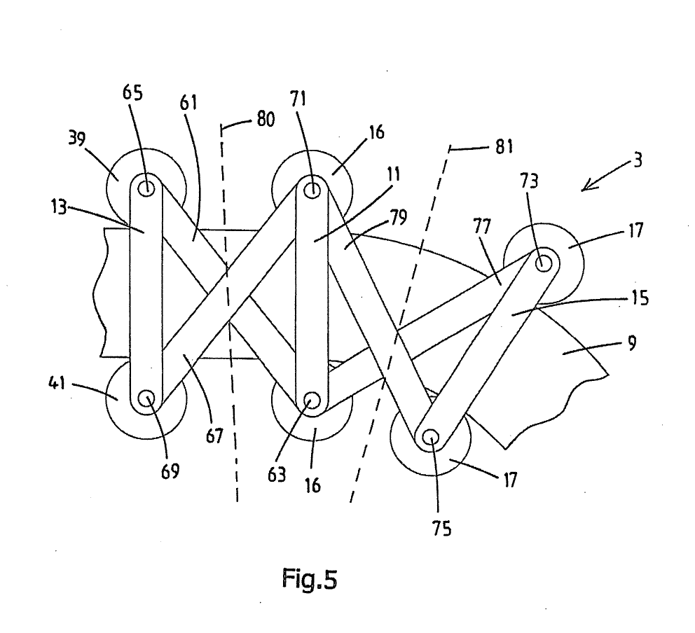

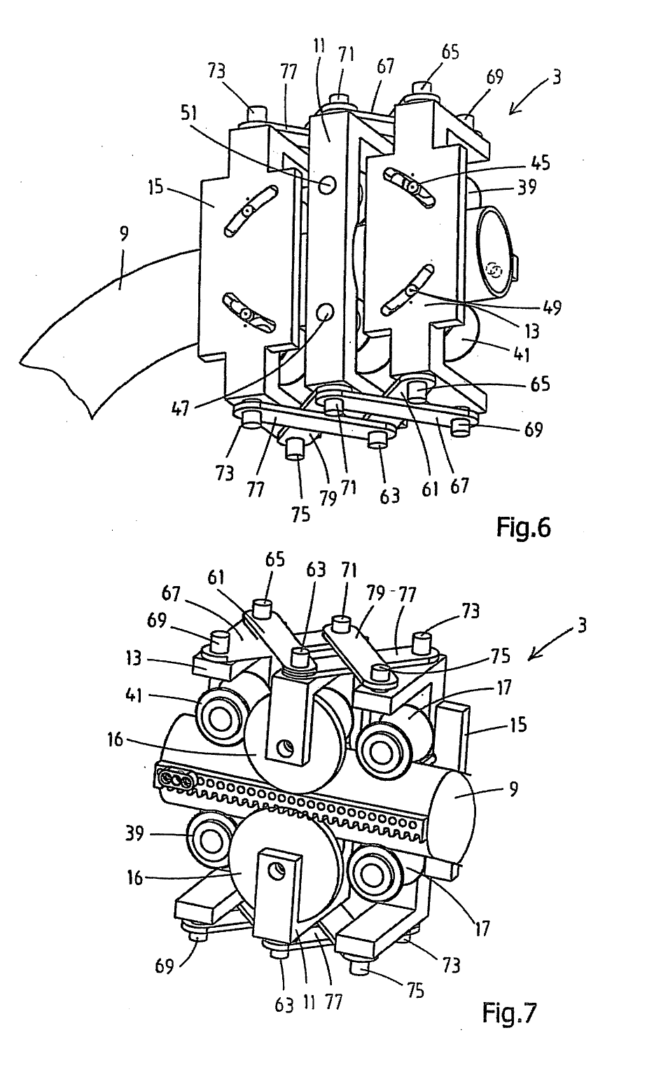

FIGS. 6 and 7 show a third embodiment of the slope lift according to the invention, wherein FIG. 7 is a view from below of the transport unit from FIG. 6. Components in the third embodiment which correspond to components in the first and second embodiments are denoted by corresponding reference numerals. The slope lift is provided with a transport unit 3 which comprises a first and second subframe 13, 15 and a main frame 11 which can be advanced over a guide rail 9. In the figure, a section of the guide rail 9 may be seen; in reality, the guide rail will be slightly longer than it is shown here. The first and second subframe 13, 15 are provided with two guide wheels 17, 39, 41 and the main frame 11 is provided with two main frame guide wheels 16. The first subframe 13 has been connected to the main frame 11 via first subframe hinge points 65, first connecting rods 61 and first main frame hinge points 63. By now connecting second connecting rods 67 to second main frame hinge points 71 via second subframe hinge points 69, wherein the first and second connecting rods 61, 67 intersect each other, the movements of the subframe 13 and the main frame 11 can be reflected with respect to a first mirror plane located between the guide wheels 39, 41 of the first subframe 13 and the wheels 16 of the main frame 11. In this embodiment, the mirror plane is located halfway between the main frame 11 and the first subframe 13 at the intersection of the connecting rods 61, 67.

The second subframe 15 is connected to the first and second main frame hinge points 63, 71 by means of third and fourth subframe hinge points 73, 75 and intersecting third and fourth connecting rods 77, 79, as a result of which the movements between the second subframe 15 and the main frame 11 can be reflected over a second mirror plane. By coupling the first and second subframe 13, 15 mirror-symmetrically to the main frame 11 in such a way that mirror planes lie between the main frame 11 and the subframes 13, 15, the first and second subframe 13, 15 and the main frame 11 move over the guide rail 9 in such a way that the frames 11, 13, 15 stand predominantly at right angles to the guide rail 9. The wheels of the frames 11, 13, 15 are as a result continuously in a position with respect to the guide 9 such that the running plane of the wheel in question is located parallel to a tangent line of the guide. An advantage of the connecting rods and hinge points is the fact that the hinge points are less sensitive to play than the pin/slot connections and as a result can position the wheels with greater precision over a longer time.

The first subframe 13 is provided with a running mechanism comprising two guide wheels 39, 41 and a first wheel holder. The first wheel holder 43 is connected to the first subframe 13 via a first wheel holder rotation point 45 which is embodied as a fifth pin which is suspended in the subframe 13 via a fifth slot. The fifth slot has a centre line which describes a portion of a circle having a constant distance with respect to a fifth main frame rotation point which lies on a third axis of rotation 47 of the main frame. The third axis of rotation 47 can optionally be formed by the axis of rotation of a main frame guide wheel 16 of the main frame. A second wheel holder rotation point 49 is embodied as a sixth pin which is movably suspended via a sixth circular slot in the first subframe 13 and can perform a circular movement with respect to a sixth main frame rotation point which lies on a fourth axis of rotation 51 of the main frame. The first and second wheel holder rotation point 45, 49 are movable with respect to the fifth and sixth main frame rotation point in the same second plane. The second plane will be curved somewhat when the first subframe 13 is tilted by an upward or downward bend of the transport unit 3 on the guide 9.

The second subframe 15 is provided with a substantially identical wheel holder which is connected to the second subframe 15 in a comparable manner to that in which the wheel holder 43 is connected to the first subframe 13 and which can move in a comparable manner with respect to the fifth and sixth main frame rotation point (the axes of rotation 47 and 51). Both wheel holders move as a result in a mirror-symmetrical manner from the main frame in the second plane, and because the subframes also move in a mirror-symmetrical manner with respect to the main frame in the first plane, good guidance is ensured in both planes. The guide wheels of the subframes and the drive wheel, support wheel and the main frame guide wheels of the main frame are as a result continuously in a position with respect to the guide such that the running plane of the wheel in question is located parallel to a tangent line of the guide in such a way that each wheel can pass, when passing through a bend in the guide, through said bend while rolling in an optimum manner.

This provides good guidance for bends in two dimensions. As an alternative, the main frame guide wheels 16 of the main frame 11 can be replaced by a support wheel or a drive wheel; this has the advantage that these wheels are well aligned with respect to the guide rail 9. Furthermore, it is possible to use one or more of the guide wheels as the drive wheel and to omit or not to omit the drive wheels of the main frame. These and many comparable adaptations and variations are deemed to fall within the scope of the invention.

1. A slope lift for climbing or descending a slope or stairs along a guide, provided with a transport unit, configured to be carried by the guide and to advance along the guide,
wherein the transport unit comprises a main frame and a first and second subframe,
wherein the subframes are provided with at least two guide wheels which guide the transport unit along the guide, and the main frame is provided with a main frame guide wheel and a drive wheel connected to a drive which advances the transport unit along the guide,
wherein the first subframe and the main frame are coupled together in such a way that the movements of the guide wheels of the first subframe and the wheels of the main frame are mirror-symmetrical with respect to a first plane of symmetry located between the guide wheels of the first subframe and the wheels of the main frame.

2. The slope lift according to claim 1, wherein the first subframe is provided with a first and a second subframe rotation point, the first subframe rotation point is movably suspended with respect to a first main frame rotation point of the main frame in such a way that it can perform a partial circular movement about the first main frame rotation point and that the second subframe rotation point is movably suspended with respect to a second main frame rotation point of the main frame in such a way that it can perform a partial circular movement about the second main frame rotation point.

3. The slope lift according to claim 1, wherein the first subframe and the main frame are movable with respect to each other in the same first plane.

4. The slope lift according to claim 2, wherein the first and second subframe rotation point are embodied as a first and second pin which can move through a first and second slot formed in the main frame.

5. The slope lift according to claim 4, wherein the first and second slot have the shape of a section of a circle having a radius running from the first or second main frame rotation point of the main frame.

6. The slope lift according to claim 1, wherein the second subframe and the main frame are coupled together in such a way that the movements of the second subframe and the main frame are mirror-symmetrical with respect to a second plane of symmetry located between the guide wheels of the second subframe and the wheels of the main frame.

7. The slope lift according to claim 6, wherein the second subframe is provided with a third and fourth subframe rotation point, the third subframe rotation point is movably suspended with respect to a third main frame rotation point of the main frame in such a way that it can perform a partial circular movement about the third main frame rotation point and that the fourth subframe rotation point is movably suspended with respect to a fourth main frame rotation point of the main frame in such a way that it can perform a partial circular movement about the fourth main frame rotation points.

8. The slope lift according to claim 6, wherein the first and third main frame rotation point lie on the same first axis and the second and fourth main frame rotation point lie on the same second axis.

9. The slope lift according to claim 1, wherein the first subframe is provided with a running mechanism comprising the at least two guide wheels and a wheel holder.

10. The slope lift according to claim 9, wherein the wheel holder is connected to the first subframe via a first wheel holder rotation point which is movably suspended with respect to a fifth main frame rotation point of the main frame in such a way that it can perform a partial circular movement about the fifth main frame rotation point and a second wheel holder rotation point which is movably suspended with respect to a sixth main frame rotation point of the main frame in such a way that it can perform a partial circular movement about the sixth main frame rotation point.

11. The slope lift according to claim 9, wherein the wheel holder is movable with respect to the subframe in the same second plane.

12. The slope lift according to claim 11, wherein the first and second plane stand perpendicularly to each other.

13. The slope lift according to claim 2, wherein the first subframe is connected to the main frame via the first subframe rotation point, a first connecting rod and the first main frame rotation point, and via the second subframe rotation point, a second connecting rod and the second main frame rotation point and wherein the first and second connecting rod intersect each other.

14. The slope lift according to claim 13, wherein the first subframe is provided with a running mechanism comprising the at least two guide wheels and a wheel holder.

15. The slope lift according to claim 14, wherein the wheel holder is connected to the first subframe via a first wheel holder rotation point which is movably suspended with respect to a fifth main frame rotation point of the main frame in such a way that it can perform a partial circular movement about the fifth main frame rotation point and a second wheel holder rotation point which is movably suspended with respect to a sixth main frame rotation point of the main frame in such a way that it can perform a partial circular movement about the sixth main frame rotation point.
